(19) United States
(12) Patent Application Publication
(10) Pub. No.: US 2023/0355033 A1
(43) Pub. Date: Nov. 9, 2023

(54) MULTI-POINT ADJUSTABLE CENTER-BOX SMOKER GRILL

(71) Applicant: W.C. BRADLEY CO., Columbus, GA (US)

(72) Inventors: DAN CORSO, Columbus, GA (US); BRAD GILLESPIE, Midland, GA (US); BRIAN BARNETT, FORTSON, GA (US); RAMIN KHOSRAVI RAHMANI, Columbus, GA (US); SCOTT LAWRENCE WAYLAND, Columbus, GA (US)

(21) Appl. No.: 18/121,813

(22) Filed: Mar. 15, 2023

Related U.S. Application Data
(60) Provisional application No. 63/320,034, filed on Mar. 15, 2022.

(51) Int. Cl. A47J 37/07

(52) U.S. Cl. CPC A47J 37/0713; A47J 37/0786

(57) ABSTRACT

A cooking device has a cooking chamber and a firebox affixed to a bottom of the cooking chamber and in fluid communication with the cooking chamber.

### CROSS-REFERENCE TO RELATED CASES

This application claims the benefit of U.S. provisional patent application Ser. No. 63/320,034, filed on Mar. 15, 2022, and incorporates such provisional application by reference into this disclosure as if fully set out at this point.

### FIELD OF THE INVENTION

This disclosure relates to outdoor cooking in general and, more specifically, to solid fuel smokers.

### BACKGROUND OF THE INVENTION

Current solid fuel smokers have a firebox and a cooking chamber. A smokebox or firebox is placed adjacent to the cooking chamber in an offset position. There is a cutout on the wall shared between the firebox and cooking chamber. The cutout allows for the travel of the combustion products from the offset firebox into the cooking chamber. The cutout also allows for transfer of the heat from the burning solid fuel inside the firebox into the cooking chamber. However, this radiation is highly concentrated on the single side of the cooking chamber that shares a wall with the firebox. In fact, excess radiative heat makes a portion of the cooking chamber near the firebox too hot and unsuitable for most cooking purposes. The offset positioning of the firebox also contributes to lack of even distribution of the temperature in the cooking chamber. It also leads to substantial loss of energy—about two-third of the energy generated in the firebox is lost through its walls.

There are horizontal smokers with the firebox mounted under the cooking chamber. These may reduce heat loss. However, these systems still suffer from excessive radiative heat at the cooking region neighboring the firebox and the lack of adjustment mechanism.

What is needed is a device, system, and methods for overcoming these and related issues.

### SUMMARY OF THE INVENTION

The invention of the present disclosure, in one aspect thereof, comprises a cooking device having a cooking chamber, and a firebox affixed to a bottom of the cooking chamber and in fluid communication with the cooking chamber. The firebox has an internal fuel grate, and an air intake receiving combustion air from outside the firebox.

Some embodiments include a baffle system controlling fluid flow from the firebox into the cooking chamber. The baffle system may comprise a pair of rotatable stacked plates, each having a plurality of cutouts defined therein such that the rotatable plates maybe rotated with respect to one another to alter a degree of fluid flow allowed through the pair of plates. The baffle system further may comprise a pair of nested cylindrical walls with one of each of the pair of nested cylindrical walls affixed to one of each of the pair of rotatable plates and extending upwardly therefrom.

In some cases, the pair of nested cylindrical walls defines a plurality of cutouts such that the nested cylindrical walls rotate with their respective affixed plates to alter a degree of fluid flow allowed laterally through the nested cylindrical walls. The degree of fluid flow laterally through the pair of nested cylindrical walls may decrease as the degree of fluid flow through the pair of plates increases. The degree of fluid flow laterally through the pair of nested cylindrical wall may increase as the degree of fluid flow through the pair of plates increases.

The baffle system may further include a perforated wall extending below the nested cylindrical walls and/or a diffuser inside the pair of nested cylindrical walls above the pair of plates.

The invention of the present disclosure, in another aspect thereof, comprises a cooking device having a cooking chamber defined by upper and lower portions between end walls, a cooking grate inside the cooking chamber, a firebox attached to the lower portion of the cooking chamber spaced apart from the end walls, the firebox being in fluid communication with the cooking chamber, and a damper interposing the firebox and a center portion of the cooking grate, the damper being adjustable to allow combustion products to rise from the firebox to the center portion of the grate, and to diffuse combustion products rising from the firebox.

In some instances, the damper comprises a radial damper. The radial damper may have first and second stacked components, each defining a set of cutouts with a degree of overlap that is altered by rotation of one of the first and second stacked components to alter fluid flow through the radial damper.

The cooking device may further include a pair of nested cylindrical walls, a first one of the pair being connected to and extending upwardly from the first stacked component, a second one of the pair being connected to and extending upwardly from the second stacked component. In some cases, the first and second nested cylindrical wall walls each define at least one cutout, the at least one cutout of the first cylindrical wall being adjustable by rotation to overlap or not overlap with the at least on cutout of the second cylindrical wall to alter fluid flow through the first and second nested cylindrical wall walls.

The cooking device can include: a diffuser plate inside the pair of nested cylindrical wall walls above the damper; a perforated wall supporting radial damper and nested cylindrical walls inside the cooking chamber, spaced apart from the firebox; and/or a pair of adjustable smoke stacks spaced apart on the upper portion of the cooking chamber, each of the pair of adjustable smoke stacks having and adjustable damper to control fluid flow from the smokestacks. When present each of the pair of adjustable smoke stacks may be further adjustable for height.

The invention of the present disclosure, in another aspect thereof, comprises a cooking device with a cooking chamber defined by an upper portion, a lower portion, and two spaced apart end portions, a firebox attached to the lower portion of the cooking chamber and in fluid communication with the cooking chamber, and a baffle system inside the cooking chamber controlling direction of combustion gases from the firebox toward a food support inside the cooking chamber. The baffle system includes a radial damper that is adjustable by a handle extending outside the cooking chamber and the firebox to pass combustion products therethrough and to diffuse combustion products radial away from the radial baffle; a pair of nested cylindrical walls extending upwardly from the radial damper and defining an opening therethrough that adjusts with adjustment of the radial baffle to allow combustion products to pass through the pair of nested cylindrical walls or be impeded from passing through the pair of nested cylindrical walls, a diffuser plate above the radial baffle, and a perforated wall extending downwardly from the radial damper.

The cooking device can include a pair of height and flow adjustable smoke stacks affixed to the upper portion of the cooking chamber spaced apart from one another.

### BRIEF DESCRIPTION OF THE DRAWINGS

FIG. 1A is a perspective view of a charcoal smoker/grill according to the present disclosure.

FIG. 1B is a partial cutaway perspective view of a charcoal smoker/grill according to the present disclosure.

FIG. 2 is a cutaway perspective view of a charcoal smoker/grill according to the present disclosure.

FIG. 3A is a cutaway frontal view of a charcoal smoker/grill according to the present disclosure operating in a sear mode.

FIG. 3B is a cutaway frontal view of a charcoal smoker/grill according to the present disclosure operating in a smoking mode.

FIG. 4A is a closeup simplified cutaway view of a charcoal smoker/grill according to the present disclosure operating with two open smokestacks.

FIG. 4B is a closeup simplified cutaway view of a charcoal smoker/grill according to the present disclosure operating with a single open smokestack.

FIG. 5A is a close-up simplified cutaway view of a charcoal smoker/grill according to the present disclosure operating in a smoking mode.

FIG. 5B is a close-up simplified cutaway view of a charcoal smoker/grill according to the present disclosure operating in a searing mode

FIG. 6A is a perspective view of an adjustable firebox baffle according to the present disclosure.

FIG. 6B is another closeup perspective view of an adjustable firebox baffle according to the present disclosure with adjustment handle and lower sidewall removed.

FIG. 6C is an exploded perspective view of the adjustable firebox baffle of FIG. 6B.

FIG. 7A is a closeup inferior perspective view of an adjustable smokestack cap according to the present disclosure.

FIG. 7B is an exploded view of the adjustable smokestack cap of FIG. 7A.

FIG. 8A is a side view of an adjustable smokestack in a lowed configuration according to the present disclosure.

FIG. 8B is a side view of an adjustable smokestack in a mid-level configuration according to the present disclosure.

FIG. 8C is a side view of an adjustable smokestack in a raised configuration according to the present disclosure.

### DETAILED DESCRIPTION OF THE PREFERRED EMBODIMENTS

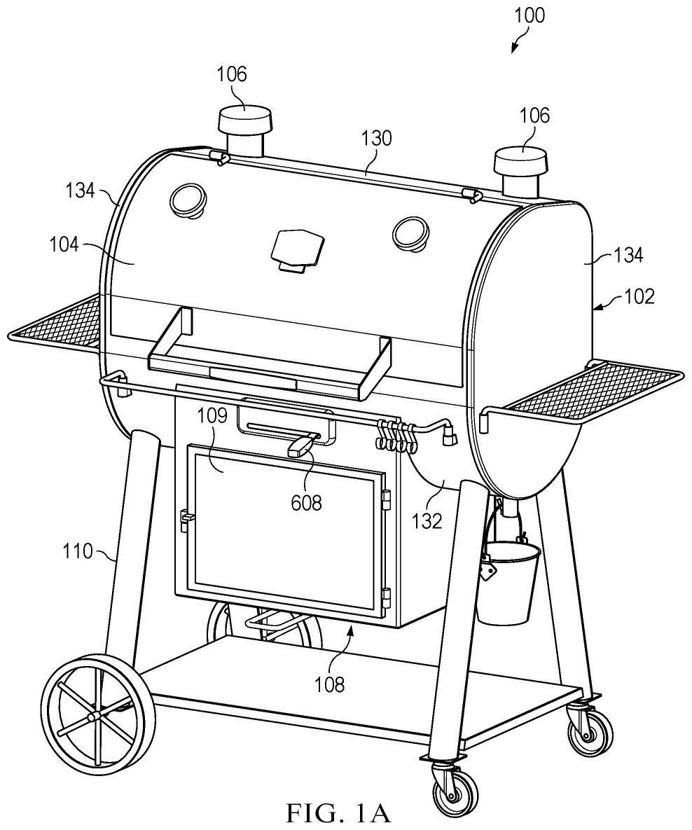

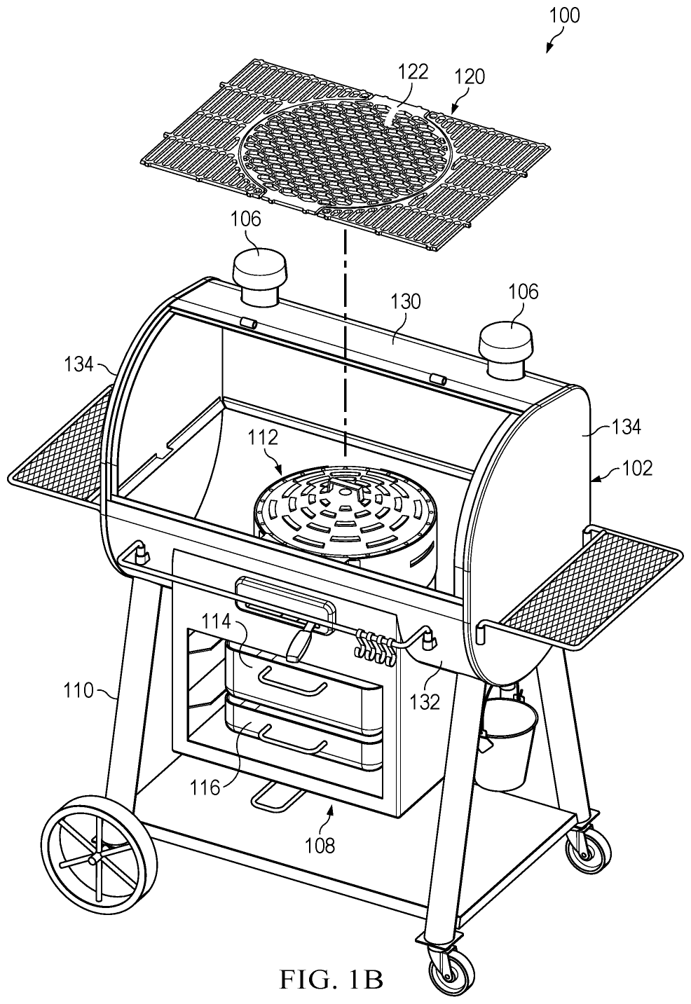

Referring now to FIG. 1A, a perspective view of a grill 100 according to the present disclosure is shown. Referring also to FIG. 1B, a partial cutaway perspective view of the grill 100 is shown. It should be understood that the grill 100 is a cooking device that is capable of cooking operations other than what might be considered traditional grilling. For example, the grill 100 also has smoking capabilities and can be internally and externally reconfigured as explained herein to alter operations between grilling, smoking, and possibly other operations. The use of the term “grill” is not meant to be limiting with respect to the grill 100 which should be considered to be a “cooking device” unless otherwise specifically stated.

The grill 100 and other embodiments of the present disclosure may comprise a cooking chamber 102. The cooking chamber 102 may be defined by an upper portion 130, a lower portion 132, and a pair of spaced apart end pieces 134. The cooking chamber 102 may be generally cylindrical but is not necessarily strictly so, and other geometries are possible. A firebox 108 may be attached to the cooking chamber and in fluid communication therewith. Unlike prior systems, the firebox 108 is attached to the lower portion 132 rather than communicating through the end pieces 134. The firebox 108 may be centrally located (front to back, and/or side to side) on the lower portion 132. In some embodiments, the firebox 108 and/or some components associated with the firebox 108 may extend into the cooking chamber 102 or be contained in the cooking chamber 102. The cooking chamber 102 and/or firebox 108 may be supported on a stand 110.

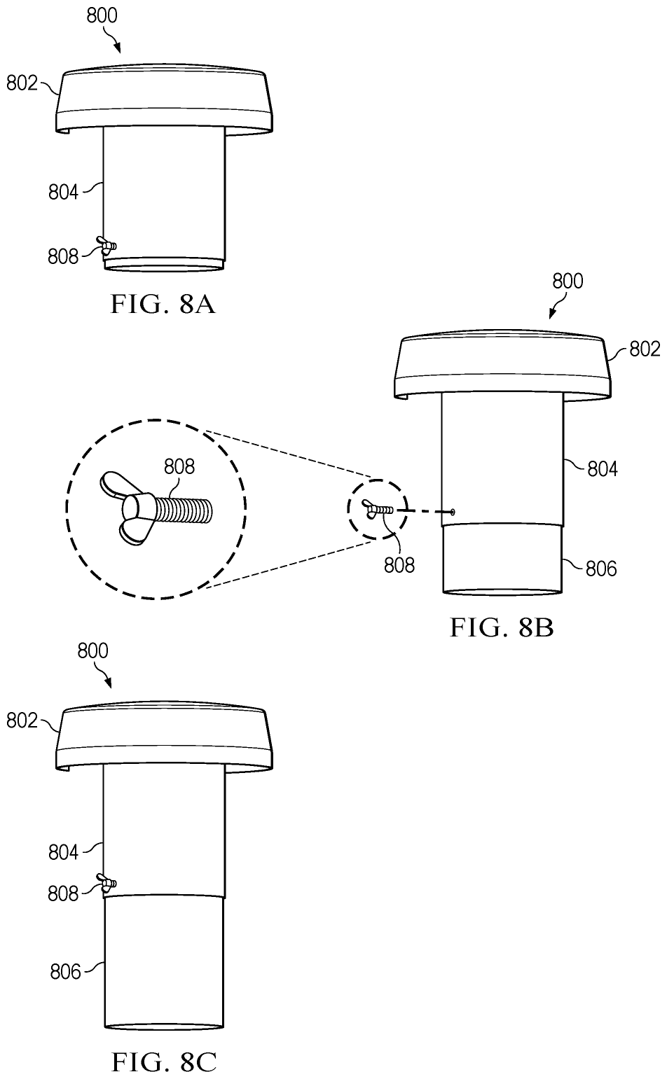

An adjustable baffle system 112 may control both radiative and convective heat transfer from the firebox 108 into the cooking chamber 102 where food is placed for cooking. Adjustable smokestacks or flue pipes 106 may be provided to control flow of gases out of the cooking chamber 102. Some embodiments may have smokestacks configured differently such as the smokestack 800 shown in FIG. 8 and discussed further below.

The cooking chamber 102 may have an openable lid 104 on the upper portion 130 allowing access to interior components and placement and removal of food items. Various racks, grates, hooks, and other implements for retaining food during smoking or cooking operations may be provided (these may be referred to generally as “food supports”). For simplicity and illustrative purposes, a single food support is shown as the single grate 120 (removed from its place in the cooking chamber 102 above the baffle system 112). A central sear zone 122 may be directly over the baffle system 112 for searing operations as discussed in greater detail below.

The firebox 108 may comprise an openable door 109 on one side thereof (e.g., the front) that may allow access to a fuel chamber 114 above an ash receptacle 116. The fuel chamber 114 and ash receptable 116 may be arranged as drawers for ease of access.

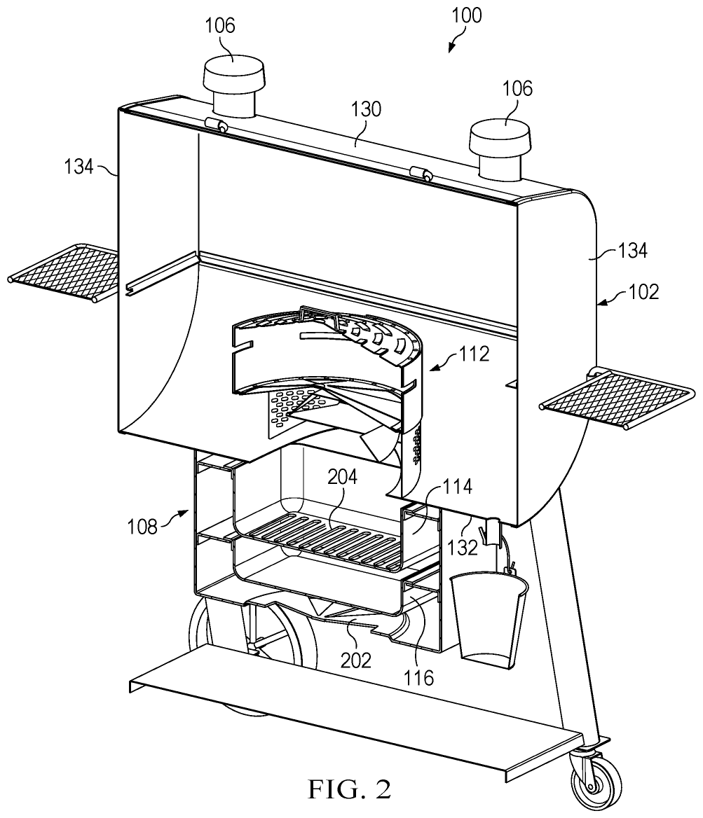

Referring now to FIG. 2, a cutaway perspective view of the grill 100 is shown. The baffle system 112 may be situated atop or above the firebox 108. A fuel grate 204 may be provided in the fuel chamber 114. Fresh air may enter the firebox 108 from the bottom via a butterfly damper 202 and travel around the ashtray 116 to reach solid fuel on the charcoal rack or fuel grate 204. Various embodiments of the system 100 are designed in such a way that intake air is provided symmetrically and only from the bottom to enhance the smoldering/combustion of solid fuel. The combustion products travel upward and through the adjustable baffle 112 into the cooking chamber 102. As explained herein, different combinations of how the firebox baffle 112 and each of the smokestacks 106 (or flue pipes 800) are set allow for a large variety of cooking scenarios that can be achieved with ease and accuracy.

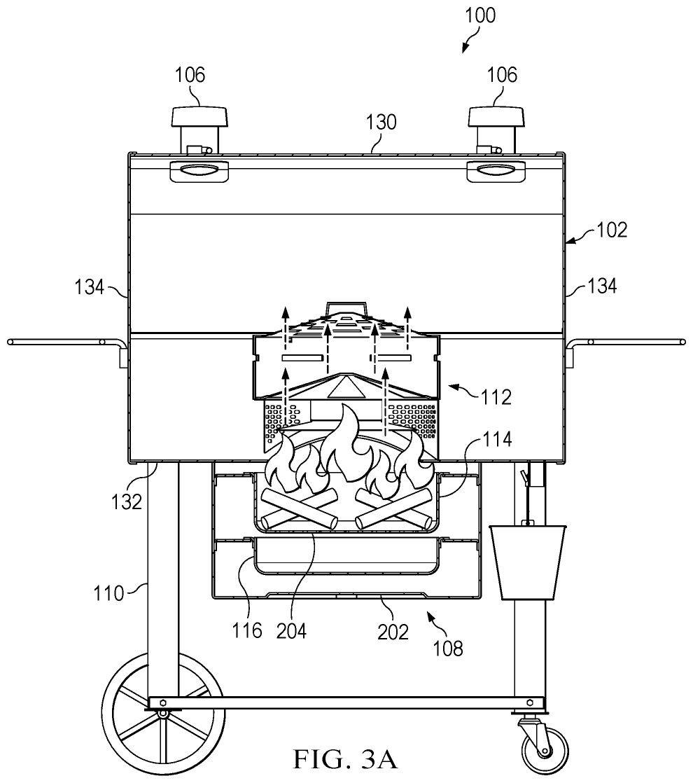

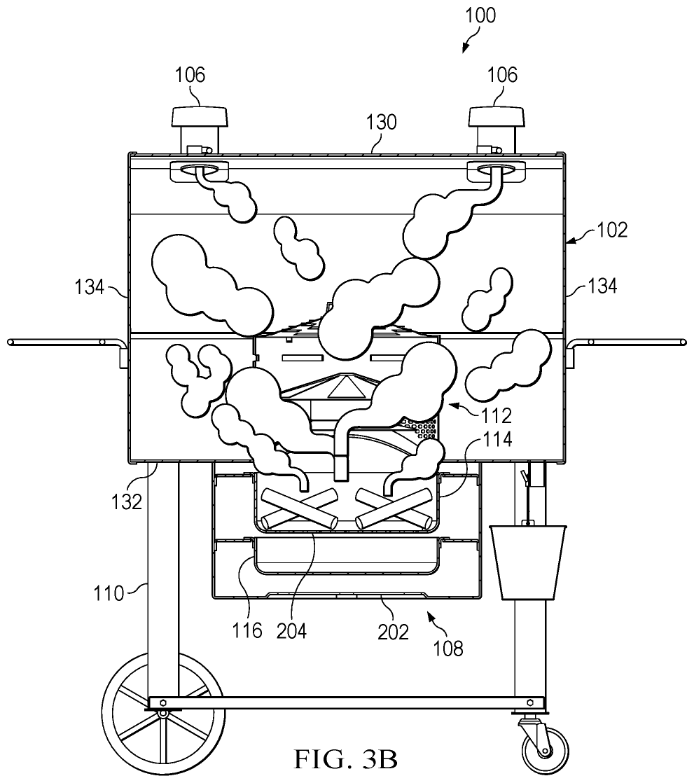

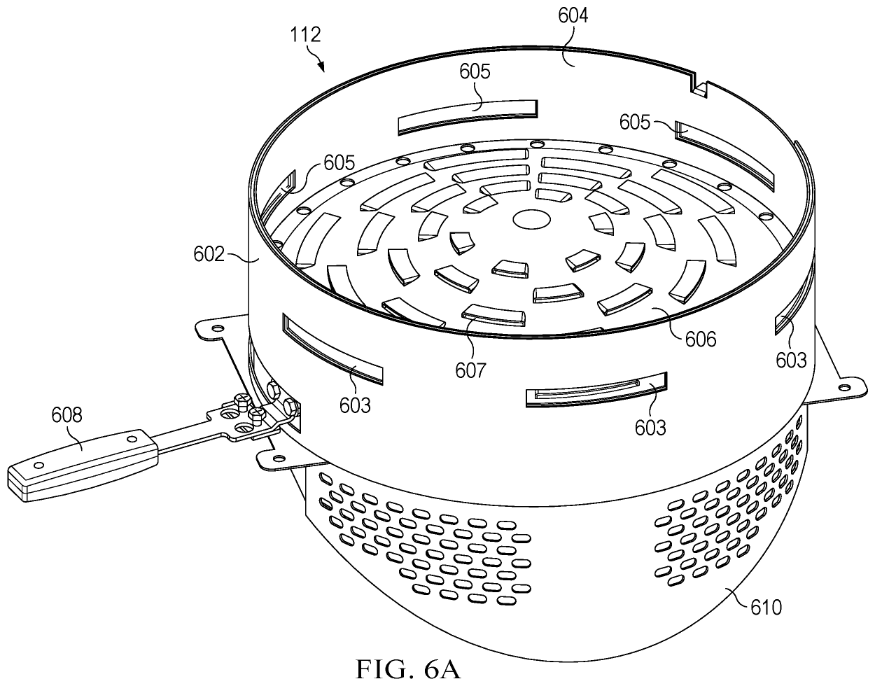

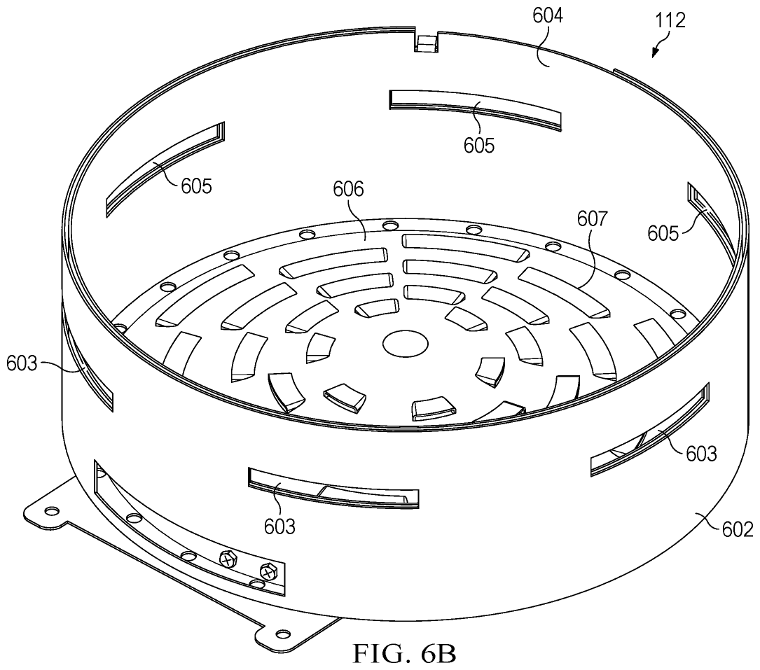

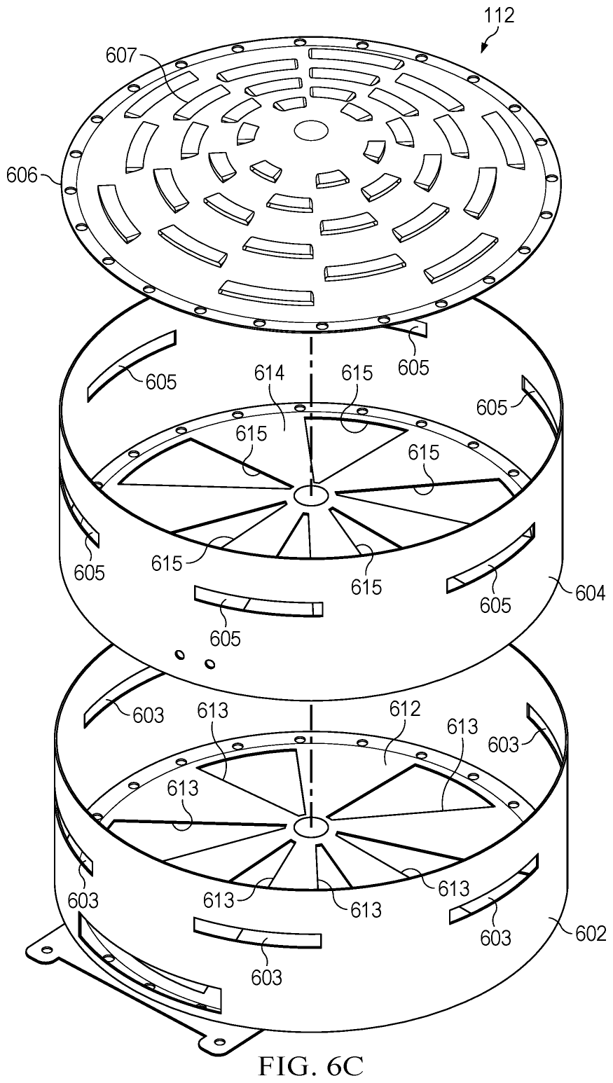

Referring now to FIG. 3A cutaway frontal view of the grill 100 is shown operating in a sear mode according to aspects of the present disclosure. Referring also to FIG. 3B a cutaway frontal view of a grill 100 operating in a smoking mode according to the present disclosure is shown. Using a shifter handle (608, FIG. 6A) a user may select between sear mode (FIG. 3A) and smoke mode (FIG. 3B) in the cooking chamber 102. The user may adjust the air damper 202 and the firebox baffle 112 to switch between smoking, grilling, and searing and/or to fine-tune the smoking/grilling/searing process.

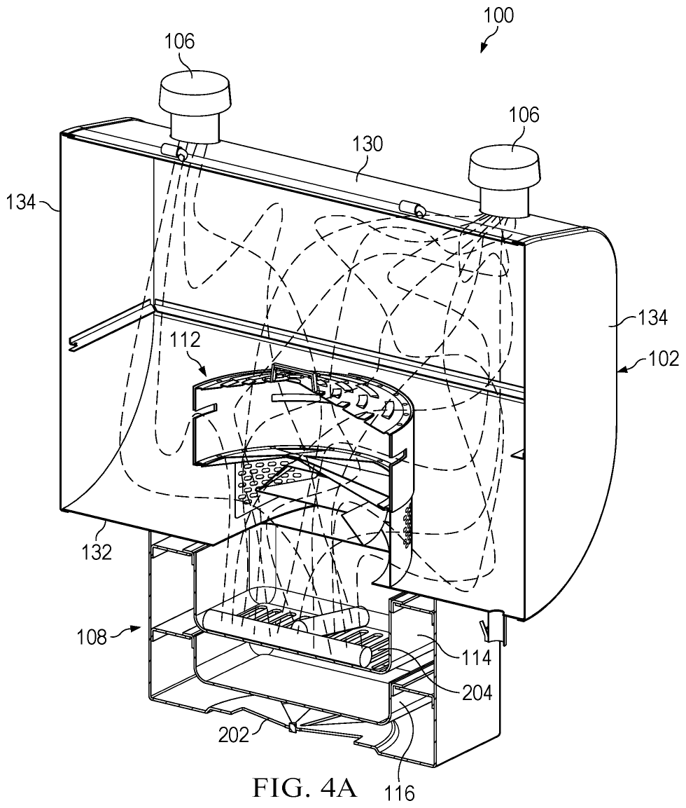

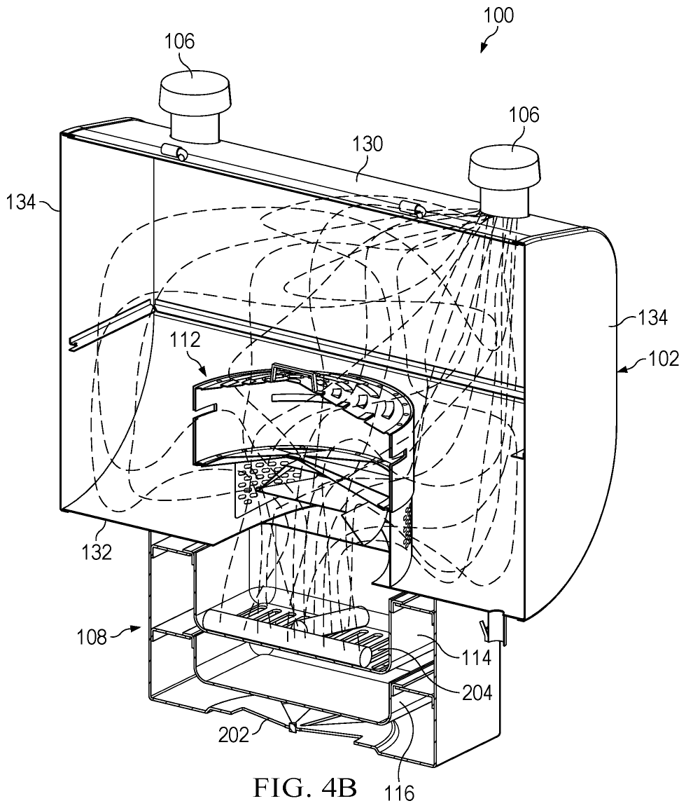

Smokestacks 106 may be adjustable with respect to the amount of exhaust flow allowed from the cooking chamber 102. FIGS. 4A-4B illustrate two examples of smokestack settings. In FIG. 4A one smokestack 106 is partially open while the other is more fully open. In FIG. 4B only one smokestack 106 is open. The user may choose among a verity of desired cooking scenarios ranging from distribution of smoke and heat to specific parts of the firebox 108 to a fully indirect smoking operation. When both smokestacks 106 are open to approximately the same degree, the symmetric firebox 108 allows for uniform cooking (across all the cooking surface or at the central sear zone 122, which may receive sufficient heat for searing operations).

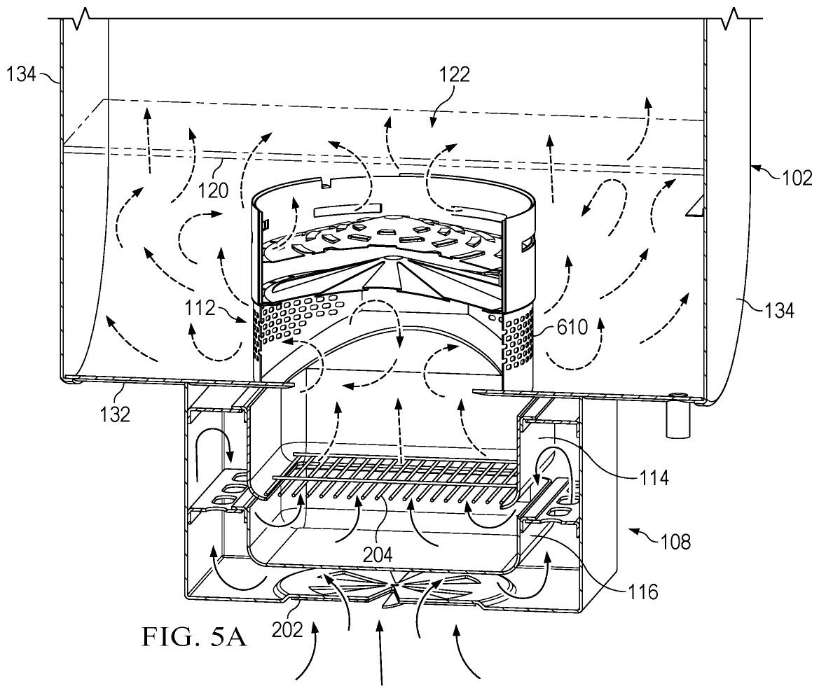

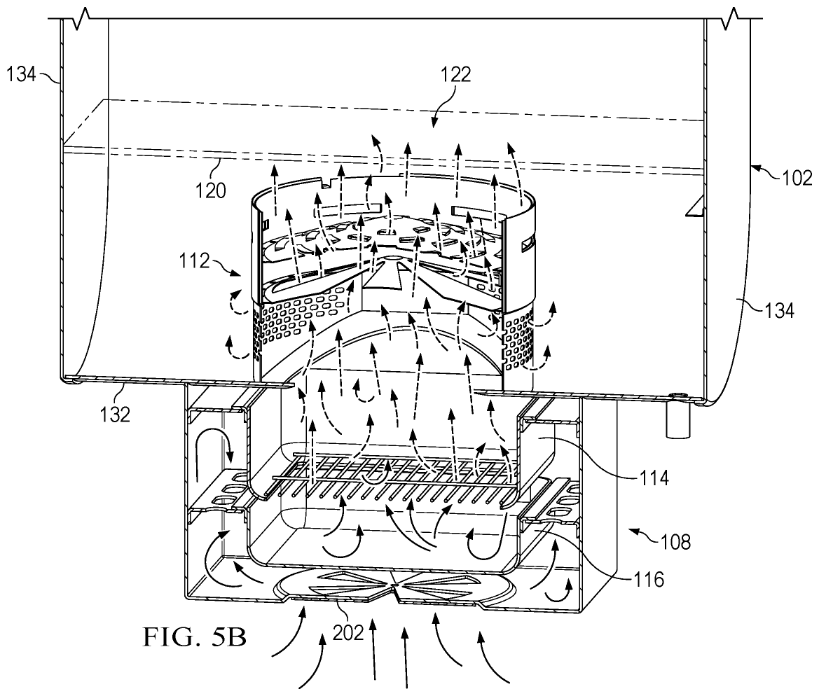

Referring now to FIG. 5A, a close-up simplified cutaway view of the grill 100 is shown operating in a smoking mode according to the present disclosure is shown. Referring also to FIG. 5B, a close-up simplified cutaway view of the grill 100 operating in a searing mode according to the present disclosure is shown. An adjustable baffle or air intake 202 may be present on a lower portion or bottom of the firebox 108. Adjustment of the air intake 202 between open and closed, as well as the state of the baffle system 112 may also alter cooking characteristics of the grill 100. The air intake 202 may allow more air into the firebox 108 for a hotter fire and less air for a slower, smokier fire.

In a smoking mode, the air damper 202 is partially open allowing limited air to be supplied to the solid fuel (on grate 204) resulting in the smoldering of the fuel. The baffle system 112 is arranged in a manner to reduce or prevent vertical or upward flow of smoke. Smoke is instead directed it into the cooking chamber 102 via perforated side walls 610. The closed baffle system 112 also acts as a radiation shield, preventing the center of the cooking chamber 102 from overheating or otherwise getting too hot for desirable smoking operations.

In a searing or grilling mode (e.g., FIG. 5B) the air damper 202 is fully open to provide sufficient air for full combustion of the solid fuel. The firebox baffle system 112 is open allowing for the flue gas and the radiation generated by the solid fuel to emit upward towards a sear zone at the center of the cooking chamber 102. Perforated side walls 610 of the baffle system 112 limit the amount of heat transferred laterally and help with the concentration of high heat at the sear zone 122 (i.e., the center of the cooking chamber 102).

Referring now to FIG. 6A, a perspective view of an embodiment of the adjustable baffle system 112 according to the present disclosure is shown. The adjustable baffle system 112 controls and directs flow of combustion products and other gases. This may be generally referred to as fluid flow. The adjustable baffle system 112 may include an outer cylindrical wall 602 containing a nested and rotatable inner cylindrical wall 604. The outer cylindrical wall 602 defines a plurality of slots or openings 603 that correspond to a plurality of slots or openings 605 defined in the inner cylindrical wall 604. The cylindrical wall 604 may be rotated with respect to the outer cylindrical wall 602 via manipulation of a shifter handle 608. The shifter handle 608 may be accessible by a user outside the cooking chamber 102 and the firebox 608 as can be seen in FIG. 1. Movement of the shifter handle 608 causes openings 603, 605 to be aligned or to occlude one another, thus controlling lateral fluid flow through the cylindrical walls 602, 604.

In some embodiments, a diffuser plate 606 may be placed or affixed on or within the inner cylindrical wall 604 to further diffuse smoke and combustion products selectively allowed to pass upward through the inner cylindrical wall 604. The diffuser plate 606 may be on a vertical level below the openings 603, 605. The diffuser plate 606 itself may define a number of openings 607, which may be angled or form louvres for directing gas flow. The openings 607 are illustrated as being configured to direct gas or fluid flow in a radial direction, which may further the effect of the cylindrical walls 602, 604, but could be configured to direct or allow gas flow primarily vertically, for example. Functionally, the diffuser plate 606 may also serve to more evenly distribute heat proximate the sear zone.

Below the cylindrical walls 602, 604 may be perforated side walls 610. The side walls 610 may descended generally vertically from the cylindrical walls 602, 604 but terminate along a curve conforming to the shape of the bottom interior of the lower portion 132 of cooking chamber 102. In some embodiments, a single sidewall may descend from the cylindrical walls 602, 604 and be perforated along all of part of its circumference.

Referring now to FIG. 6B is another closeup perspective view of the baffle system 112 from a steeper angle. The handle 608 and perforated sidewalls 610 are not shown in this view.

Referring now to FIG. 6C is an exploded perspective view of the baffle system 112 is shown. The cylindrical walls 602, 604 may extend upwardly from a radial damper defined by an stacked plates. An upper plate 614 may have cutouts 615 defined therein. A lower plate 612 may have cutouts 615 defined therein. The plates 612, 614 may be flat or slightly conic or domed toward a center thereof, with sides or edges that join or attach to their respective cylindrical walls 602, 604. The cutouts 613, 615 may comprise triangular or wedge-shaped openings in the plates 612, 614, respectively. The cutouts 613, 615 may be arranged such that they overlap to admit gas (fluid) flow, or do not overlap (e.g. they are occluded) to prevent gas flow, depending upon the rotation of the cylindrical walls 602, 604 with respect to one another.

Depending on relative positioning of the inner cylindrical wall 604 and outer cylindrical wall 602, direct transfer of radiative and convective heat vertically upward may be limited to created more smoke and/or limited or diffused heat as might be useful in smoking or baking. This configuration can be seen in operation in FIG. 5A. In this configuration the openings 613, 615 in the plates 612, 614 are closed or occluded. However, the openings 603, 605 in the cylindrical walls 602, 604 are aligned. Thus heat and smoke are forced to flow out of the baffle system 112 via the perforated sidewalls 610 while the openings 603, 605 allow indirect smoke and gas flow even to the center of the cooking chamber 102.

On the other hand, when the baffle system 112 is configured for grilling or searing (as in FIG. 5B), the plates 612, 614 are rotated such that openings 613, 615 allow for maximum direct flow of heat and combustion products upward toward the grate 120, and particularly the sear zone 122. The cylindrical walls 602, 604 may be rotated such that their openings 603, 605 are blocked to retain a maximum heating effect directly above the baffle system 112 (e.g., at the sear zone 122).

It will be appreciated that the plates 612, 614 could be affixed to outer cylindrical wall 602 and inner cylindrical wall 604, respectively, such that the openings 603, 605 align when the openings 613, 615 align. In such an embodiment smoke and gases may not readily flow back into an upper portion of the baffle system 112 (e.g. above the diffuser 606) during smoking or baking operations but more heat may be transferred to the entire grate 120 during grilling/searing operations as gas and heat could flow outward through the openings 603, 605 when the openings 613, 615 in the plates 614, 612 are aligned.

It should also be understood that greater or lesser degrees of opening may be achieved between the openings 603, 605 as well as between the openings 613, 615 (e.g., cylindrical walls 602, 604 and/or plates 612, 614 may be partially openable as well as fully opened or closed). In some embodiments, the outer cylindrical wall 602 may rotate with respect to the inner cylindrical wall 604 rather than the inner cylindrical wall 604 being rotatable within the outer cylindrical wall 602.

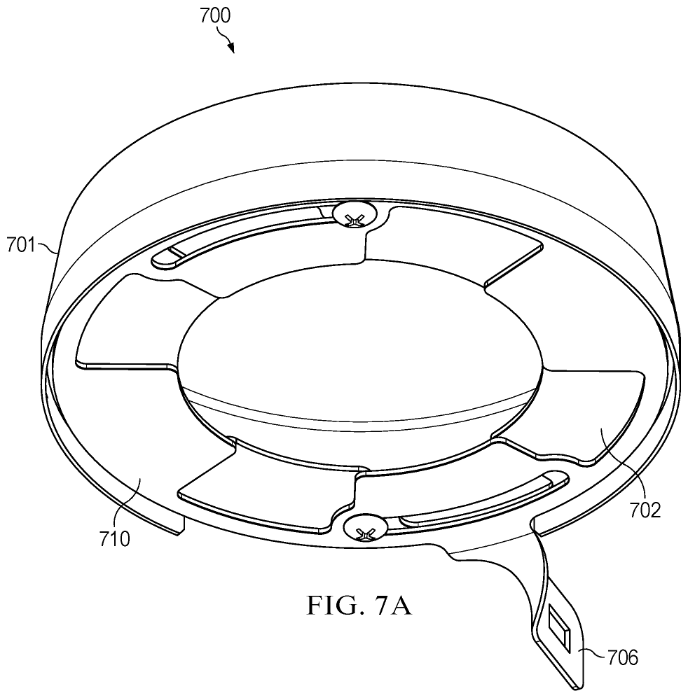

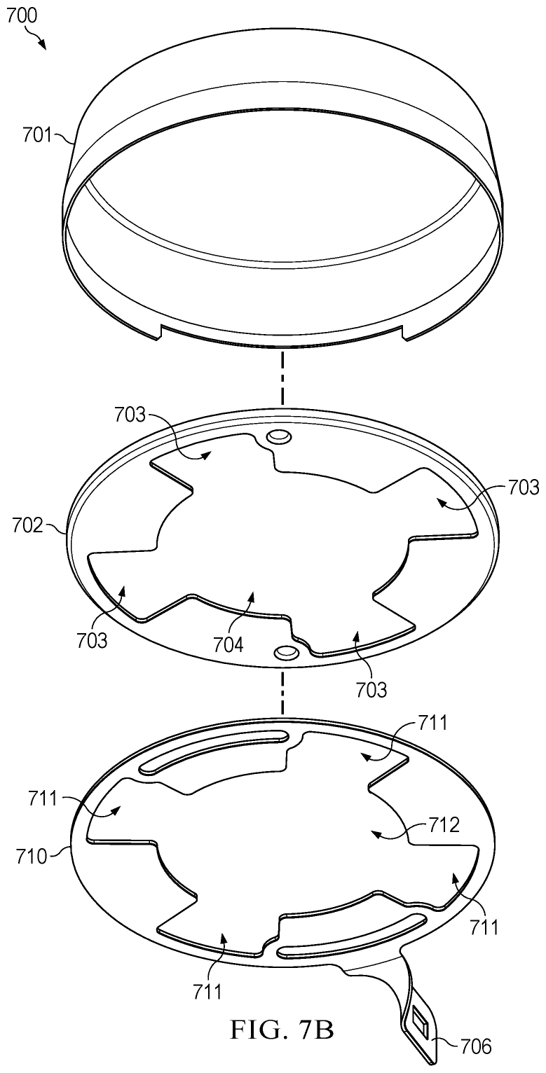

Referring now to FIG. 7A is a closeup inferior perspective view of an adjustable smokestack cap 700 according to the present disclosure is shown. Referring also to FIG. 7B is an exploded view of the adjustable smokestack cap 700 of FIG. 7A is shown. The cap 700 may contain a damper valve comprising an upper piece 702 formed from a plate having cutouts 703 surrounding a central opening 704. A lower piece 710 may comprise a plate with cutouts 711 surrounding a central opening 712. The lower piece 710 fits against the upper piece 702 such that the central openings 712, 704 are aligned. The lower piece 710 may be rotatable with respect to the upper piece 702 (or vice versa) such that the openings 711, 703 may be aligned to allow gas flow or misaligned to block gas flow. A handle 706, shown attached to the lower piece 710, may be provided to allow adjustment of the openings 711, 703 and the damping effects of the cap 700.

The upper piece 702 and possibly the lower piece 710 may be fitted in or to a top 701 of the cap 700. The aligned central openings 712, 704 allow gas flow into the cap but exit from the cap is controlled by the damping or alignment of the upper piece 702 and lower piece 710.

Referring now to FIG. 8 a side view of an adjustable flue pipe 800 in a lowered configuration according to the present disclosure is shown. Referring also to FIGS. 8B and 8C, the flue pipe 800 is shown in a mid-level and a lowered configuration, respectively. FIGS. 8A-C illustrate various states the adjustable flue pipe 800 allowing for creating different level of buoyancy driven draft that can be used to fine-tune the level of smoke in the cooking chamber 102 (e.g., when fitted to the smokestacks 106). A top cap 802 is affixed to an upper tube 804 containing a slidable nested lower tube 806. A removable fastener such as a winged screw 808 may be used to secure the upper tube 804 in relative position with respect to the lower tube 806. The lower tube 806 may be fitted to the cooking chamber 102. Adjustable flue pipes 800 may be used instead of or in addition to the smokestacks 106 and may also be equipped with an adjustable cap (e.g., cap 700).

It will be appreciated that embodiments of the present disclosure provide more accurate and better control of the temperature and heat in the cooking chamber 102 by adjusting the means of radiative and convective heat transfer from the firebox 108 into the cooking chamber 102. Adjustable air damper 202 and smokestacks 116 (or flue pipes 800) allows for fine-tuning of each desired cooking mode from low temperature smoking to high temperature searing.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cooking device comprising:
a cooking chamber; and
a firebox affixed to a bottom of the cooking chamber and in fluid communication with the cooking chamber;
wherein the firebox has an internal fuel grate, and an air intake receiving combustion air from outside the firebox.

2. The cooking device of claim 1, further comprising a baffle system controlling fluid flow from the firebox into the cooking chamber.

3. The cooking device of claim 2, wherein the baffle system comprises:
a pair of rotatable stacked plates, each having a plurality of cutouts defined therein such that the rotatable plates maybe rotated with respect to one another to alter a degree of fluid flow allowed through the pair of plates.

4. The cooking device of claim 3, wherein the baffle system further comprises:
a pair of nested cylindrical walls with one of each of the pair of nested cylindrical walls affixed to one of each of the pair of rotatable plates and extending upwardly therefrom.

5. The cooking device of claim 4, wherein each of the pair of nested cylindrical walls defines a plurality of cutouts such that the nested cylindrical walls rotate with their respective affixed plates to alter a degree of fluid flow allowed laterally through the nested cylindrical walls.

6. The cooking device of claim 5, wherein the degree of fluid flow laterally through the pair of nested cylindrical walls decreases as the degree of fluid flow through the pair of plates increases.

7. The cooking device of claim 5, wherein the degree of fluid flow laterally through the pair of nested cylindrical wall increases as the degree of fluid flow through the pair of plates increases.

8. The cooking device of claim 5, wherein the baffle system further comprises a perforated wall extending below the nested cylindrical walls.

9. The cooking device of claim 8, wherein the baffle system further comprises a diffuser inside the pair of nested cylindrical walls above the pair of plates.

10. A cooking device comprising:
a cooking chamber defined by upper and lower portions between end walls;
a cooking grate inside the cooking chamber;
a firebox attached to the lower portion of the cooking chamber spaced apart from the end walls, the firebox being in fluid communication with the cooking chamber;
a damper interposing the firebox and a center portion of the cooking grate, the damper being adjustable to allow combustion products to rise from the firebox to the center portion of the grate, and to diffuse combustion products rising from the firebox.

11. The cooking device of claim 10, wherein the damper comprises a radial damper.

12. The cooking device of claim 11, wherein the radial damper comprises first and second stacked components, each defining a set of cutouts with a degree of overlap that is altered by rotation of one of the first and second stacked components to alter fluid flow through the radial damper.

13. The cooking device of claim 12, further comprising a pair of nested cylindrical walls, a first one of the pair being connected to and extending upwardly from the first stacked component, a second one of the pair being connected to and extending upwardly from the second stacked component.

14. The cooking device of claim 13, wherein the first and second nested cylindrical wall walls each define at least one cutout, the at least one cutout of the first cylindrical wall being adjustable by rotation to overlap or not overlap with the at least on cutout of the second cylindrical wall to alter fluid flow through the first and second nested cylindrical wall walls.

15. The cooking device of claim 13, further comprising a diffuser plate inside the pair of nested cylindrical wall walls above the damper.

16. The cooking device of claim 13, further comprising a perforated wall supporting radial damper and nested cylindrical walls inside the cooking chamber, spaced apart from the firebox.

17. The cooking device of claim 13, further comprising a pair of adjustable smoke stacks spaced apart on the upper portion of the cooking chamber, each of the pair of adjustable smoke stacks having and adjustable damper to control fluid flow from the smokestacks.

18. The cooking device of claim 17, wherein each of the pair of adjustable smoke stacks is further adjustable for height.

19. A cooking device comprising:
a cooking chamber defined by an upper portion, a lower portion, and two spaced apart end portions;
a firebox attached to the lower portion of the cooking chamber and in fluid communication with the cooking chamber; and
a baffle system inside the cooking chamber controlling direction of combustion gases from the firebox toward a food support inside the cooking chamber, the baffle system comprising:
a radial damper that is adjustable by a handle extending outside the cooking chamber and the firebox to pass combustion products therethrough and to diffuse combustion products radial away from the radial baffle;
a pair of nested cylindrical walls extending upwardly from the radial damper and defining an opening therethrough that adjusts with adjustment of the radial baffle to allow combustion products to pass through the pair of nested cylindrical walls or be impeded from passing through the pair of nested cylindrical walls;
a diffuser plate above the radial baffle; and
a perforated wall extending downwardly from the radial damper.

20. The cooking device of claim 19, further comprising a pair of height and flow adjustable smoke stacks affixed to the upper portion of the cooking chamber spaced apart from one another.
